(19) United States
(12) Patent Application Publication
(10) Pub. No.: US 2024/0051195 A1
(43) Pub. Date: Feb. 15, 2024

(54) Apparatus and Method for Controlling the Alignment of Fiber Loops in Compression Molded Articles

(71) Applicant: Arris Composites Inc., Berkeley, CA (US)

(72) Inventors: Sam PIRAHANCHI, Novato, CA (US); Erick DAVIDSON, Piedmont, CA (US); Jalen MANO, Oakland, CA (US); J. Scott PERKINS, Oakland, CA (US)

(21) Appl. No.: 18/086,670

(22) Filed: Dec. 22, 2022

Related U.S. Application Data
(60) Provisional application No. 63/293,601, filed on Dec. 23, 2021.

(51) Int. Cl. B29C 43/36; B29C 43/00

(52) U.S. Cl. CPC B29C 43/361; B29C 43/006; B29C 2043/3628

(57) ABSTRACT

A compression-molding apparatus includes a sleeve plunger and a core pin. The sleeve plunger is movable through a plunger cavity that, in some embodiments, extends through the male portion of the molding apparatus. The sleeve plunger has a bore, and is received by and movable along the core pin, which typically extends upward into the plunger cavity from the female portion of the molding apparatus. In addition to any other functionality, the core pin forms a hole in a molded part. In operation, the fiber-bundle-based-preform feed constituents are placed in the plunger cavity. If any of the preforms are ring-shaped preforms, they are received by the core pin.

### STATEMENT OF RELATED CASES

This specification claims priority to U.S. 63/293,601, which was filed Dec. 23, 2021 and is incorporated herein by reference.

### FIELD OF THE INVENTION

The present invention pertains to compression molding.

### BACKGROUND OF THE INVENTION

Openings or holes are often required in fiber-composite parts. They facilitate attaching one part to another, can serve as a conduit, and provide a host of other functions.

The presence of a hole, particularly a fiber-composite part, affects the distribution of the stresses arising therein when subjected to an external loading. More particularly, the presence of a hole redistributes and localizes stresses as compared to a hole-free part. Since stress concentrations around holes can lead to part failure, the subject is of considerable importance.

A rigorous analysis of stresses around a hole, particularly in fiber-composite parts, is very complex. But as a general proposition, it is beneficial to improve the hoop (circumferential) strength of a part in the region around a hole. This can be done, for example, by aligning the fibers near the hole to follow its circumference.

However, such alignment is not possible for most prior-art compression-molding processes as a consequence of the feed constituents used. For example, most such processes use bulk molding compound (a mixture of randomly oriented short fibers and resin in pelletized form), sheet molding compound (sheets of resinous material in which fibers are unidirectionally aligned), or tape/ribbon (ribbons of resinous material in which fibers are unidirectionally aligned). There is no (or very limited) ability to create the aforementioned circular alignment using such feed constituents.

Moreover, fibers in the vicinity of the hole that are sourced from such feed constituents tend to align with one another during the compression-molding sequence and form a “weld” (or “knit” or “meld”) line. A weld line is a defect caused by the inability of two or more liquefied-resin/fiber flow fronts to combine at the location at which they meet. The defect presents as a “line” in the part, negatively impacts a desired fiber alignment, and results in a locally weak region.

Applicant's compression-molding processes utilize fiber-bundle-based preforms, such as fabricated from segments of towpreg. These preforms, which comprise thousands of co-aligned, resin-impregnated fibers, can be formed into a circular shape to establish a desired circular fiber orientation around a hole. However, a variety of issues can arise during processing that ultimately result in misalignment of the preform/fibers relative to the hole. A few examples are described below.

Referring now to FIG. 1A, in some of applicant's own prior compression-molding processes, fiber-bundle-based preforms are injected into mold cavity 104 via plunger 102. In such processes, there is no significant constraint on fiber orientation. Consequently, ring-shaped preform 106, which is intended to encircle a hole, can “tilt” within plunger cavity 100 as it is forced into mold cavity 104. This can result, for example, in the fiber alignment depicted in FIG. 1B, wherein ring-shaped preform 106 is offset hole 112 in part 110 being formed. (Note that after the melt-flow state is attained, the preform resolves into a plurality of separate fibers, but for clarity of illustration, such fibers are shown as remaining grouped together as a preform).

Referring now to FIGS. 2A and 2B, and once again discussing applicant's own prior compression-molding processes, FIG. 2A depicts ring-shaped preform 106 undesirably advancing beyond linear preforms 208 during the heating or injection sequence. Once preform 106 settles in cavity 104, it may “unwind” since the fibers in linear preforms 208, which enter the mold cavity after preform 106, may force fibers 206 sourced from ring-shaped preform 106 outwardly. FIG. 2B depicts the resulting fiber alignment around hole 112.

More generally, after the resin in a ring-shape preform reaches its melt-flow state, and when subjected to the turbulence imparted by the high pressures (often several thousand psi) of applicant's compression-molding processes, the fibers in the ring-shape preform will tend to realign, such that the desired circular fiber alignment is lost. FIG. 3 depicts examples of deformation of (the fibers from) ring-shape preforms 306A and 30613 when subjected to turbulence or other non-uniform forces.

### SUMMARY

The present invention provides a way to establish and maintain a desired circular fiber alignment around a hole or other substantial circular/oval feature.

In accordance with the illustrative embodiment of the present invention, a compression-molding tool includes a “sleeve plunger” and a “core pin.” The sleeve plunger is movable through a plunger cavity that, in an illustrative embodiment, extends through the male portion of the molding apparatus. The sleeve plunger, which has a bore aligned with its longitudinal axis, is received by and movable along the core pin, which typically extends upward into the plunger cavity from the female portion of the molding tool.

In operation, the fiber-bundle-based-preform feed constituents are placed in the plunger cavity. If any of the preforms are ring-shaped preforms, they are received by the core pin. During compression molding, the sleeve plunger moves downwardly sliding along the core pin, forcing any preforms into the mold cavity. In addition to other functionality, the core pin forms a hole in a molded part. Since the core pin defines the location of the hole being formed in the part, the ring-shaped preform(s), sliding along the core pin, will be directed to the hole and necessarily surround it as desired.

The presence of the core pin, other fibers present in the mold cavity, and, at least for a time, the continued downward pressure imparted by the sleeve plunger, ensure that during the compression-molding process, the ring-shape preform does not move, unwind, or in any way deviate from the desired alignment/orientation around the hole. To the extent that linear preforms were present in the plunger cavity, the fibers sourced therefrom will be free to move beyond the region of the hole, their ultimate location dictated by their size, pressure gradients within the molding cavity, and turbulence of the melted resin flow.

In some embodiments, the sleeve plunger comprises multiple “sleeve” sections, which may or may not be independent actuatable. In some embodiments, at least some of the multiple sleeve sections have a different length than other of the sections. In some embodiments, the compression molding apparatus includes two or more sleeve plungers, all of which move through a single plunger cavity. For such embodiments, the plural sleeve plungers may or may not be independently actuatable.

In some embodiments, the present invention provides a compression-molding tool comprising a male portion having a plunger cavity extending therethrough; a sleeve plunger movable within the plunger cavity, the sleeve plunger having a bore therein aligned with a longitudinal axis of the sleeve plunger; a female portion having a mold cavity; and a core pin extending from the female portion, through the mold cavity, and into the plunger cavity, wherein the core pin receives the bore of the sleeve plunger, the sleeve plunger movable along the core pin within the plunger cavity.

### BRIEF DESCRIPTION OF THE DRAWINGS

FIGS. 1A and 113 depict a first manner in which a desired placement of fibers from a ring-shaped preform may be affected in one of applicant's prior compression-molding processes.

FIGS. 2A and 2B depict a second manner in which a desired placement of fibers from a ring-shaped preform may be affected in one of applicant's prior compression-molding processes.

FIG. 3 depicts two examples of the deformation of fibers from ring-shaped preforms when subjected to non-uniform forces in a mold cavity.

FIGS. 4A through 4C depict an embodiment of a molding tool including a sleeve plunger in accordance with the present invention, wherein the molding tool is depicted at various stages in a compression molding process.

FIG. 5 depicts a stylized fiber alignment for a fiber-composite part.

FIG. 6 depicts the molding tool of FIGS. 4A-4C, including an arrangement of preforms, for creating a fiber-composite part having the fiber alignment shown in FIG. 5.

FIG. 7A depicts a compression-molding tool with an off-center plunger cavity in accordance with the present teachings.

FIG. 7B depicts an illustrative fiber alignment for a part molded from the molding tool of FIG. 7A.

FIG. 8A depicts a compression-molding tool including a first alternative embodiment of a sleeve plunger in accordance with the present teachings.

FIG. 8B depicts a second alternative embodiment of a sleeve plunger in accordance with the present teachings, such as may be used in the molding tool of FIG. 8A.

FIG. 9 depicts a compression-molding tool including a third alternative embodiment of a sleeve plunger in accordance with the present teachings.

FIGS. 10A and 106 depict respective perspective and cross-sectional views of a compression-molding tool including a fourth alternative embodiment of a sleeve plunger in accordance with the present teachings.

FIGS. 11A and 11B depict respective perspective and cross-sectional views of a compression-molding tool including a fifth alternative embodiment of a sleeve plunger in accordance with the present teachings.

FIG. 11C depicts further detail of the sleeve plunger of FIGS. 11A and 11B.

FIGS. 12A through 12C depict a compression-molding tool including a sixth alternative embodiment of a sleeve plunger in accordance with the present teachings, wherein the molding tool is depicted at various stages in a compression molding process.

FIGS. 13A and 13B depict a further illustrative embodiment of a compression-molding tool in accordance with the present teachings.

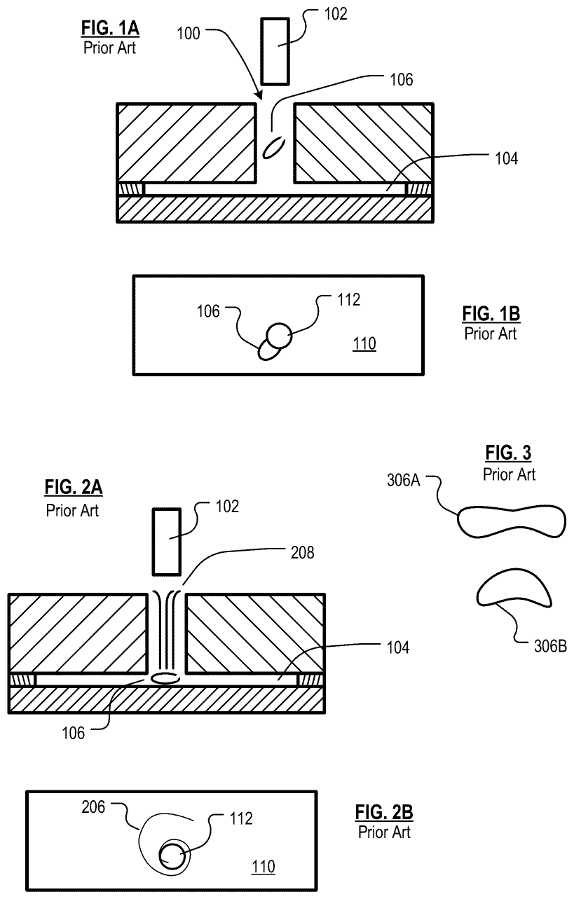

### DETAILED DESCRIPTION

Definitions. The following terms are defined for use in this description and the appended claims:

“Fiber” means an individual strand of material. A fiber has a length that is much greater than its diameter.

“Fiber bundle” means plural (typically multiples of one thousand) co-aligned fibers.

“Stiffness” in the context of a material means resistance to bending, as measured by Young's modulus. When used in the context of a spring or spring assembly, “stiffness” means resistance to displacement from an unstretched/uncompressed state.

“Tow” means a bundle of fibers (i.e., fiber bundle), and those terms are used interchangeably herein unless otherwise specified. Tows are typically available with fibers numbering in the thousands: a 1K tow (1000 fibers), 4K tow (4000 fibers), 8K tow, etc.

“Prepreg” means fibers that are impregnated with resin.

“Towpreg” means a fiber bundle (i.e., a tow) that is impregnated with resin.

“Preform” means a segment of plural, co-aligned, resin-impregnated, typically same-length fibers. The segment is cut to a specific length, and, in many cases, will be shaped (e.g., bent, twisted, etc.) to a specific form, as appropriate for the specific part being molded. Preforms are usually sourced from towpreg (i.e., the towpreg is sectioned to a desired length), but can also be from another source of plural co-aligned, unidirectionally aligned fibers (e.g., from a resin impregnation process, etc.). Preforms are preferably, but not necessarily, substantially circular or oval in cross section. Applicant's use of the term “preform” explicitly excludes: (i) tape, (ii) sheets of fiber, and (iii) laminates, cut to shape or otherwise. The modifier “fiber-bundle-based”or “aligned-fiber” may be pre-pended herein to the word “preform” to emphasize the nature of applicant's preforms and to distinguish them from prior-art preforms, which are typically in the form of tape, sheets, or shapes cut from sheets of fiber.

“Preform Charge” means an assemblage of preforms that are at least loosely bound together (i.e., tacked) so as to maintain their position relative to one another. Preform charges can contain fiber in form factors other than that of fiber bundles, and can contain various inserts, passive or active. Preform charges are not fully consolidated.

“Preform Layup” means an arrangement of individual preforms that is formed by placing preforms, one-by-one, into a mold cavity. A preform layup is distinguished from a preform charge, wherein for the latter, the preforms are at least loosely bound to one another and the assemblage thereof is usually formed outside of the mold cavity.

“Compatible” means, when used to refer to two different resin materials, that the two resins will mix and bond with one another.

“Compression molding” is a molding process that involves the application of heat and pressure to feed constituents for a period of time. The mold constituents are typically placed in a female mold portion having a mold cavity. After the requisite amount of feed constituents are placed in the female mold half, a second mold half—a male mold half— is joined to the female mold half to close the mold cavity. The male mold half usually includes features that extend into the female male half to engage the feed constituents therein. For applicant's processes, the applied pressure is usually in the range of about 500 psi to about 5000 psi, and temperature, which is a function of the particular resin being used, is typically in the range of about 150° C. to about 400° C. Once the applied heat has increased the temperature of the resin above its melt temperature, it is no longer solid and will flow. The resin will then conform to the mold geometry via the applied pressure, and the feed constituents are thereby consolidated, resulting in very little void space. Elevated pressure and temperature are typically maintained for a few minutes. After this compression molding protocol is complete, the mold is removed from the source of pressure and is cooled. Once cooled, a finished part is removed from the mold.

“Consolidate”, “consolidating”, or “consolidation” means, in the present context, that in a grouping of fibers/resin, such as plurality of preforms, void space is removed to the extent possible and as is acceptable for a final part. Feed structures lose any unique or individual identity and any previously existing boundaries between adjacent preforms are lost. This usually requires significantly elevated pressure, either through the use of gas pressurization (or vacuum), or the mechanical application of force (e.g., rollers, etc.), and elevated temperature (to soften/melt the resin).

“Partial consolidation” means, in the present context, that in a grouping of fibers/resin, void space is not removed to the extent required for a final part. As an approximation, one to two orders of magnitude more pressure is required for full consolidation versus partial consolidation. As a further very rough generalization, to consolidate fiber composite material to about 80 percent of full consolidation requires only 20 percent of the pressure required to obtain full consolidation.

“Neat” resin or other matrix material means the resin/matrix material includes no reinforcing fibers.

“About” or “Substantially” means+/−20% with respect to a stated figure or nominal value.

Additional definitions may be provided, in context, elsewhere in this specification. All patents and published patent applications referenced in this disclosure are incorporated by reference herein.

It is to be understood that any numerical range recited herein is intended to include all sub-ranges encompassed therein. For example, a range of “1 to 10” is intended to include all sub-ranges between (and including) the recited minimum value of about 1 and the recited maximum value of about 10, that is, having a minimum value equal to or greater than about 1 and a maximum value of equal to or less than about 10. As a non-limiting example, a recited range of “1 to 10 μm” includes “5 to 8 μm”, “1 to 4 μm”, “2 to 9 μm”, etc.

Feed Constituents. For embodiments of the compression-molding tool and processes disclosed herein, assemblages of preforms may be directly placed in the mold cavity and/or individual preforms may be injected therein during processing via a sleeve plunger through a plunger cavity. The preforms are typically formed from towpreg, but may also be sourced from the output of a resin impregnation line. To form a preform from towpreg or the output of a resin infusion line, the towpreg is cut into segments of a desired size and often shaped (e.g., bent, etc.) as well. Each preform include thousands of co-aligned, resin-infused fibers, typically in multiples of one thousand (e.g., 1 k, 10 k, 24 k, etc.). A preform may have any suitable cross-sectional shape (e.g., circular, oval, trilobal, polygonal, etc.), but is most typically circular or oval.

As noted above, the preforms that are placed into the mold cavity are organized into an assemblage. The assemblage may have a geometry and shape that is close to that of the part being fabricated, or a portion thereof. The preforms are positioned and oriented to provide a desired fiber alignment in a part being molded. In some embodiments, the preforms are placed one-by-one into the mold. In some other embodiments, the preforms are first organized into a “preform charge.”

A preform charge includes a plurality of preforms that are “tacked” together. The term “tacking” references heating to the point of softening (but not melting) to effectively join the preforms so as to create a single structure. In some cases, minimal compression is applied for tacking. The preform charge, which is often created in a special fixture, conforms to the shape of the mold (and hence the part), or portions of it. Because the resin in the preforms is not heated to liquefication (the preforms are typically heated to a temperature that is above the heat deflection temperature of the resin, but below the melting point), and the applied pressure is typically low (less than 100 psig and in some cases nothing more than the force of “gravity” acting on the preforms), the preform charge is not fully consolidated and thus could not function as a finished part. But once joined in this fashion, the preforms will not move, thereby maintaining the desired geometry and the specific alignment of each preform in the assemblage. See, e.g., Publ. Pat. App. US2020/0114596 and U.S. patent application Ser. No. 16/877,236.

As used herein, the term “assemblage of preforms” refers to either a lay-up of preforms, as formed by placing preforms one-by-one into a mold cavity, or to a preform charge.

As previously noted, a preform, as that term is used herein, is a bundle of resin-infused fibers. The individual fibers can have any diameter, which is typically, but not necessarily, in a range of 1 to 100 microns. The individual fibers can have any length, which is application specific, wherein the length results from the cutting operation that creates the associated preform. Individual fibers can include an exterior coating such as, without limitation, sizing, to facilitate processing, adhesion of binder, minimize self-adhesion of fibers, or impart certain characteristics (e.g., electrical conductivity, etc.).

Each individual fiber can be formed of a single material or multiple materials (such as from the materials listed below), or can itself be a composite. For example, an individual fiber can comprise a core (of a first material) that is coated with a second material, such as an electrically conductive material, an electrically insulating material, a thermally conductive material, or a thermally insulating material.

In terms of composition, each individual fiber can be, for example and without limitation, carbon, carbon nanotubes, glass, natural fibers, aramid, boron, metal, ceramic, polymer, synthetic fibers, and others. Non-limiting examples of metal fibers include steel, titanium, tungsten, aluminum, gold, silver, alloys of any of the foregoing, and shape-memory alloys. “Ceramic” refers to all inorganic and non-metallic materials. Non-limiting examples of ceramic fiber include glass (e.g., S-glass, E-glass, AR-glass, etc.), quartz, metal oxide (e.g., alumina), aluminasilicate, calcium silicate, rock wool, boron nitride, silicon carbide, and combinations of any of the foregoing. Non-limiting examples of suitable synthetic fibers include nylon (polyamides), polyester, polypropylene, meta-aramid, para-aramid, polyphenylene sulfide, and rayon (regenerated cellulose).

Any resin—thermoplastic or thermoset—that bonds to itself under heat and/or pressure can be used in conjunction with embodiments of the invention.

Exemplary thermoplastic resins useful in conjunction with embodiments of the invention include, without limitation, acrylonitrile butadiene styrene (ABS), ethylene tetrafluoroethylene (ETFE), fluorinated ethylene propylene (FEP), liquid crystal polymers (LCPs), polyamides (Nylon), polyaryletherketones (PAEK), polybenzimidazole (PBI), polybutylene terephthalate (PBT), polycarbonates (PC), and polycarbonate-ABS (PC-ABS), polyethylene (PE), polyetheretherketone (PEEK), polyetherimide (PEI), polyether sulfones (PES), polyethylene terephthalate (PET), perfluoroalkoxy copolymer (PFA), polyimide (PI), polymethylmethacrylate (PMMA), polyoxymethylene (polyacetals) (POM), polypropylene (PP), polyphosphoric acid (PPA), polyphenylene ether (PPE), polyphenylene oxide (PPO), polyphenylene sulfide (PPS), polyphenylsulfone (PPSU), Polystyrene (PS), polysulfone (PSU), polytetrafluoroethylene (PTFE), polyurethane (PU), polyvinyl chloride (PVC), styrene acrylonitrile (SAN), and styrene butadiene styrene (SBS). A thermoplastic can be a thermoplastic elastomer such as polyurethane elastomer, polyether ester block copolymer, styrenic block copolymer, polyolefin elastomer, polyether block amide, thermoplastic olefins, elastomeric alloys (TPE and TPV), thermoplastic polyurethanes, thermoplastic copolyesters, thermoplastic polyamides, and thermoplastic silicone vulcanizate.

Non-limiting examples of suitable thermosets include araldite, bakelites, epoxies, melamines, phenol/formaldehydes, polyesters, polyhexahydrotriazines, polyimides, polyisocyanates, polyureas, silicones, urea/formaldehydes, vinyl esters, phenolics, and polycarbonates. Suitable thermosets can be prepared as a partially cured B-stage.

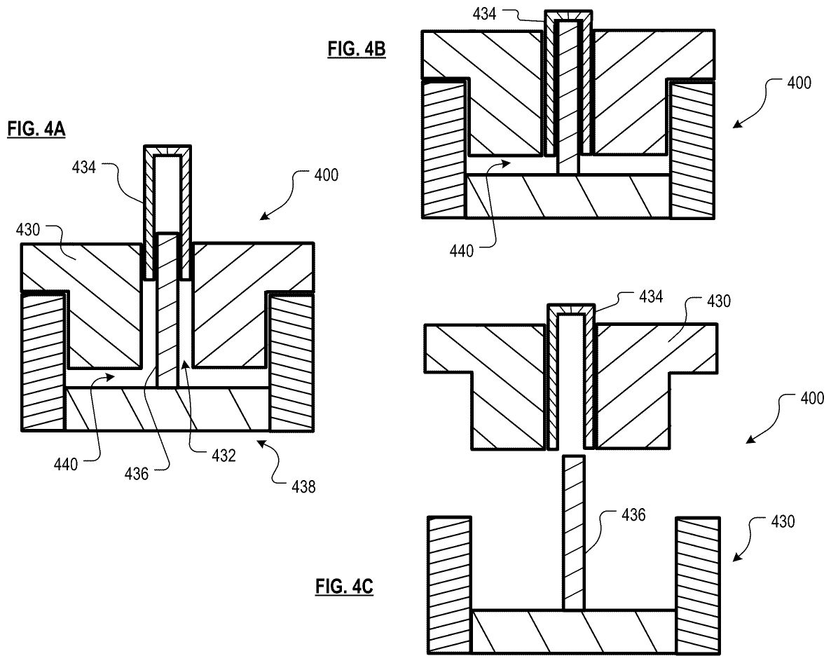

Compression-Molding Tools in Accordance with the Present Teachings. FIGS. 4A-4C depict, via cross-sectional views, an embodiment of compression molding-tool 400, including sleeve plunger 434 and core pin 436 in accordance with the present teaching. Compression-molding tool 400 includes male mold portion 430 (often referred to as the “A-Side” of the mold), and female mold portion 438 (often referred to as the “B-Side” of the mold). Extending through male mold portion 430 is plunger cavity 432. Female mold portion 438 includes mold cavity 440. Core pin 436 extends upward from female mold portion 438 and extends into plunger cavity 432. Sleeve plunger 434 is configured as a tube; that is, it has a longitudinally aligned bore, so that it can be received by core pin 436 and move along it through plunger cavity 432 when actuated to do so.

FIG. 4A depicts sleeve plunger 434 advanced slightly into plunger cavity 432 and engaged to core pin 436. FIG. 4B depicts sleeve plunger 434 fully advanced through plunger cavity 432, sealing mold cavity 440. In this position, sleeve plunger 434 has advanced any fiber-bundle-based preforms (not depicted) into mold cavity that were fed through plunger cavity 432. In FIG. 4C, molding tool 400 has been opened, such that male mold portion 430 and female mold portion 438 are separated and a part that has been molded (not depicted) has been ejected from the mold.

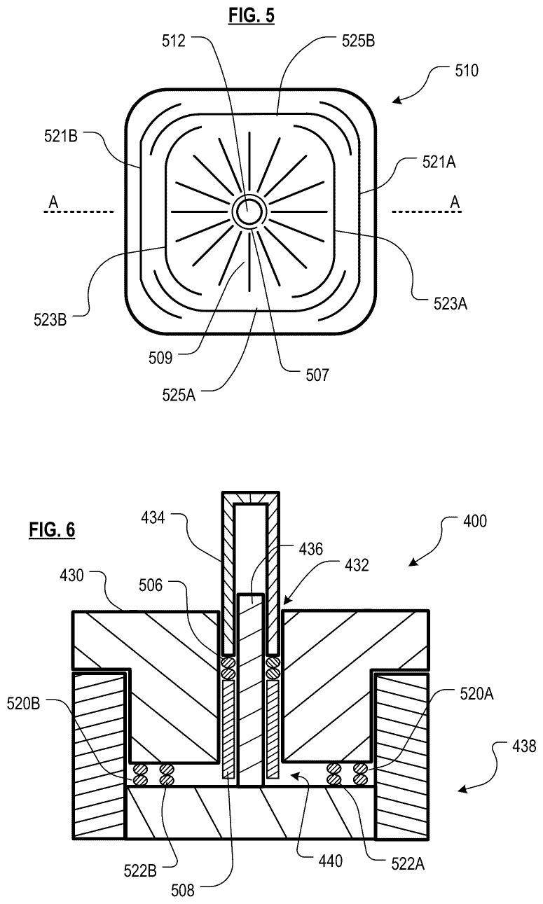

FIG. 5 depicts a stylized fiber alignment, via a top view, for fiber-composite part 510, and FIG. 6 depicts the manner in which fiber-bundle-based preforms are situated in molding tool 400 to achieve the fiber alignment of FIG. 5.

Part 510 includes centrally located hole 512. To the extent possible, fibers within part 510 align with the stress vectors expected to arise in a part when the part is in use, due to applied loads. Fibers 507, which surround hole 512 and align with its circumference, enhance hoop strength. A plurality of fibers 509 extend radially away from hole 512. Additional groups of fibers 521A/B, 523A/B, and 525A/B are disposed radially outward of fibers 509 and are substantially aligned with one of the sides of part 510. It is to be understood that there would actually be many more fibers in each of the identified groups of fibers throughout part 510.

Referring now to FIG. 6, preforms 520A and 520B are situated near the edges of mold cavity 440, in a horizontal orientation. Performs 522A and 522B are situated inward of respective preforms 520A and 520B, also in a horizontal orientation. In FIG. 6, two of each of preforms 520A, 520B, 522A, 522B are depicted in mold cavity as illustrative of the some of the feed constituents required for molding part 510. It will be appreciated that the thicker the part, the higher the stacks of preforms, to ensure that a requisite amount of fiber and resin is available for molding he part.

Preforms 520A and 520B are the source of respective groups of fibers 521A and 521B depicted in FIG. 5. Preforms 522A and 522B are the source of respective groups of fibers 523A and 523B. Not depicted in FIG. 6 are the preforms that are the source of groups of fibers 525A and 525B (due to location selected for the cross-sectional view illustrated in FIG. 6, which corresponds to the axis A-A shown in FIG. 5).

Situated within plunger cavity are linear fiber-bundle-based preforms 508, and above them, ring-shape fiber-bundle-based preforms 506. Linear fiber-bundle-based preforms 508 are the source of groups of fibers 509, and ring-shape preforms 506 are the source of fibers 507.

In operation, molding tool 400 is heated to melt the resin contained in the various preforms, and the mold cavity is pressurized. Due to their length, continuous fibers 521A/B, 523A/B, and 525A/B, as sourced from the aforementioned respective preforms, are relatively immobile and tend to remain substantially at the location at which their source preforms were placed in mold cavity 440.

As sleeve plunger 434 is advanced, fibers 509 sourced from linear preforms 508 are injected into mold cavity 440. Due to the pressure gradient resulting from the downward movement of sleeve plunger 434 through plunger cavity 432, the melted thermoplastic resin from preforms 508 is forced out of the (centrally located relative to the mold cavity) exit of plunger cavity 432 and into mold cavity 440. The resin flows radially outward due to the pressure gradient, advancing fibers 509 along with it. The fiber alignment depicted in FIG. 5 results. It is to be appreciated that fibers 509 would not be as “straight” as depicted in the stylized illustration.

Once fibers 509 exit plunger cavity 432, fibers 507 sourced from ring-shape preforms 506 are forced downward into mold cavity 440. Fibers 507 are substantially constrained from lateral movement by core pin 436, by fibers 509 that are now present in mold cavity 440, and to some extent by any continued downward pressure exerted by sleeve plunger 434. Consequently, fibers 507 surround the nascent hole being formed by the core pin. The bottom surface of sleeve plunger 434 will tend to constrain any movement in the z-direction (i.e., vertically) of fibers 507. Thus, the desired alignment of fibers 507 (i.e., surrounding hole 512) as depicted in FIG. 5 is established and maintained during the compression-molding process, and, therefore, in the resulting part.

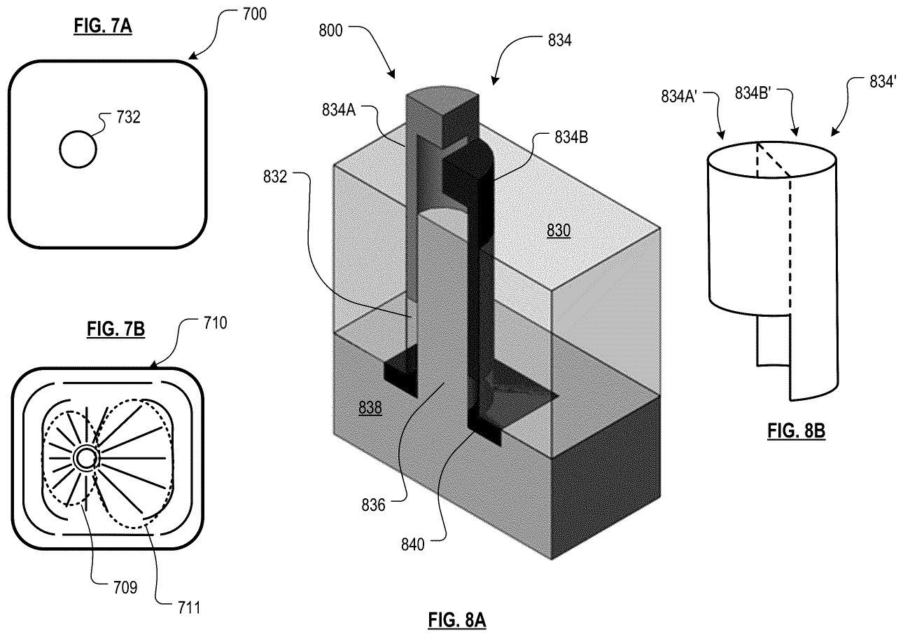

Consider a situation, such as depicted in FIG. 7A, in which plunger cavity 732 (and hence the core pin and the sleeve plunger) are not situated at the center of mold tool 700. In that situation, different lengths of preforms/fiber would be need to be injected through plunger cavity 732 to ensure sufficient fiber coverage throughout the part being formed. This is depicted in FIG. 7B, wherein part 710 includes relatively shorter fibers 709 sourced from relatively shorter preforms (not depicted), and relatively longer fibers 711 sourced from relatively longer preforms (not depicted). An equivalent scenario may arise in an asymmetrically shaped part.

To address this issue, some embodiments of a molding tool in accordance with the present teachings include a “conformal” sleeve plunger. Some embodiments of conformal sleeve plungers have multiple sleeve sections, which may or may not be independently actuatable. In some embodiments, one or more of the sleeve sections may have a different length than other of the sleeve sections. FIGS. 8A, 8B, 9, 10A-10B, 11A-11B depict several non-limiting embodiments of a conformal sleeve plunger. In some other embodiments, a conformal sleeve plunger in accordance with the present teachings includes various other adaptations for positioning/orienting fibers as required in a mold cavity.

FIG. 8A depicts a first alternative embodiment of a sleeve plunger in accordance with the present teachings. This embodiment depicts compression-molding tool 800 having male mold portion 830 having plunger cavity 832, and female mold portion 838 including mold cavity 840. Core pin 836 extends from female mold portion 838 into plunger cavity 832.

Compression-molding tool 800 also includes sleeve plunger 834. This sleeve plunger includes two independently actuatable/movable longitudinal sleeve sections 834A and 8348. Sleeve sections 834A and 8348 enable sleeve plunger 834 to inject preforms having different lengths, although in this embodiment, the sleeve sections themselves are the same length. For example, as depicted in FIG. 8A, the initial position for sleeve section 834A can be “higher” than that of sleeve section 8348, such that a relatively longer fiber-bundle-based preform can be positioned below that section for injection into mold cavity 840, and relatively shorter fiber-bundle-based preform can be positioned below sleeve section 8348. These sleeve sections can be actuated in unison, simultaneously injecting the preforms into the mold cavity, or they can be actuated sequentially. In some other embodiments, in addition to being independently actuatable/movable, the two sleeve sections can be of different lengths.

FIG. 8B depicts a second alternative embodiment of a sleeve plunger. This embodiment is also suitable for injecting preforms having different lengths into different regions of the mold cavity. But rather than having fully independent longitudinal sleeve sections like sleeve plunger 834, sleeve plunger 834′ is a unitary structure wherein a first portion of the sleeve plunger (portion 8346′) is longer than a second portion (834A′) thereof. Thus, relatively shorter linear preforms can be placed under portion 8346′ and relatively longer linear preforms can be placed under portion 834A′. In this embodiment, all preforms are injected at the same time.

Although the portions 834A′ and 8346′ are each depicted as extending for about half of the circumference of sleeve plunger 834′, they can be apportioned in any manner, as appropriate. For example, if about seventy-five percent of the mold cavity required relatively shorter preforms and about twenty-five percent required relatively longer preforms, then the longer portion should account for about seventy-five percent of the circumference of sleeve plunger 834′. Furthermore, although sleeve plunger 834′ was depicted as having two regions of different lengths, in other embodiments, such a sleeve plunger can have three or more regions of different lengths.

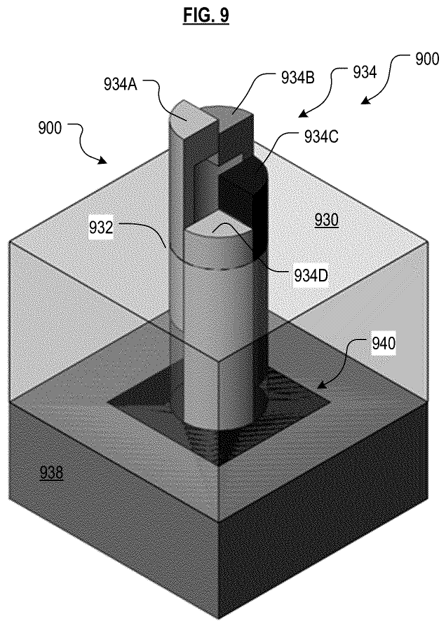

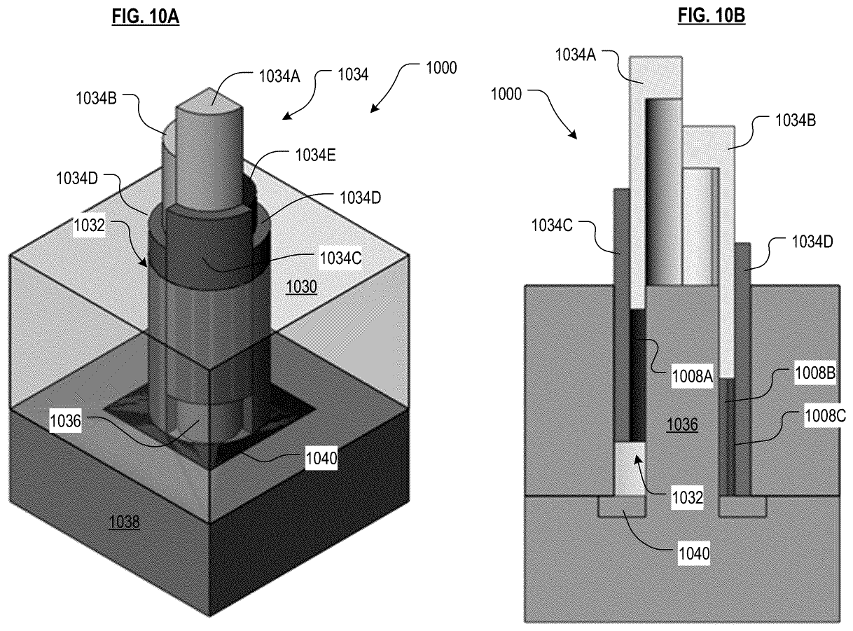

Moreover, in various embodiments, the sleeve plungers depicted in FIG. 8A, as well as any of those depicted in FIGS. 9, 10A/10B, 11A/11B, and 12A-12C, can include one or more of the following characteristics/features:
(a) Provide rotational movement within plunger cavity in addition to linear movement.
(b) One or more of the sleeve sections can be helical (or partially helical as a function of the whether the sleeve section is a full sleeve, or a segment thereof).
(c) An ability for the sleeve sections to selectively retract, to pull the preforms upward. This enables more opportunities for insertion and fiber alignment. For example, a sleeve-plunger having plural sleeve sections can insert preforms that differ from one another, such as in resin composition, fiber-volume-fraction, fiber type, etc. Having one stationary sleeve section touching the molding surface of the female mold portion will obstruct flow, dictating that the fibers flow around it. Retracting this sleeve section would enable the molten resin to fill this region, thereby carrying fibers with it.
(d) Different sleeve sections of the sleeve plunger have different angles with respect to the mold cavity (and the part being formed). This could be dictated, for example, by material/part requirements/fiber alignment requirements.

Embodiments of sleeve plunger 834′ of FIG. 8B can also include features (a) and/or (b).

FIG. 9 depicts a third alternative embodiment of a sleeve-plunger in accordance with the present teachings. This embodiment depicts compression-molding tool 900 having male mold portion 930 having plunger cavity 932, and female mold portion 938 including mold cavity 940. Core pin (not depicted) extends from female mold portion 938 into plunger cavity 932.

Compression-molding tool 900 also includes sleeve plunger 934. This sleeve plunger is similar to that of sleeve plunger 834, but instead of having two sleeve sections, sleeve plunger 934 includes four sleeve sections 934A, 9348, 934C, and 934D, at least some of which sleeve sections are independently actuatable for sequential insertion of fiber-bundle-based preforms. Such independent insertion can be required, for example, to establish a desired fiber alignment, a localized material insertion, or the mixing of materials having different properties. The four sleeve sections can all be the same lengths, or at least some of them can have lengths that differ from the lengths of other sleeve sections.

Sleeve plunger 834 is depicted as having two independent sleeve sections and sleeve plunger 934 is depicted as having four independent sleeve sections. It is to be understood that in some other embodiments, sleeve plungers having similar overall construction to sleeve plungers 834 and 934 can have a different number of independent sleeve sections (e.g., 3 sleeve sections, five sleeve sections, etc.).

FIGS. 10A and 10B depict respective perspective and cross-sectional views of a fourth alternative embodiment of a sleeve-plunger in accordance with the present teachings. These figures depict compression-molding tool 1000 having male mold portion 1030 having plunger cavity 1032, and female mold portion 1038 including mold cavity 1040. Core pin 1036 extends from female mold portion 1038 into plunger cavity 1032.

Compression-molding tool 1000 additionally includes sleeve plunger 1034. This sleeve plunger includes five sleeve sections 1034A, 103413, 1034C, and 1034D, and 1034E, some of which are concentrically arranged with respect to other of the sleeve sections. Each of the sleeve sections have the same length and at least some of the sleeve sections are independently actuatable with respect to other sleeve sections. In some other embodiments, the lengths of one or more of the sleeve sections can differ from the length of other sleeve sections. And in some further embodiments, such a sleeve plunger can include a different number of concentrically arranged sleeve sections.

This embodiment of a sleeve plunger is particularly well suited for the following scenarios, among any others:
One or more of the sleeve sections can be used as a dam to prevent mixing of different types of preform feeds.
One or more of the sleeve sections can be used as a fiber alignment aid to block the flow of fiber and resin, as appropriate.

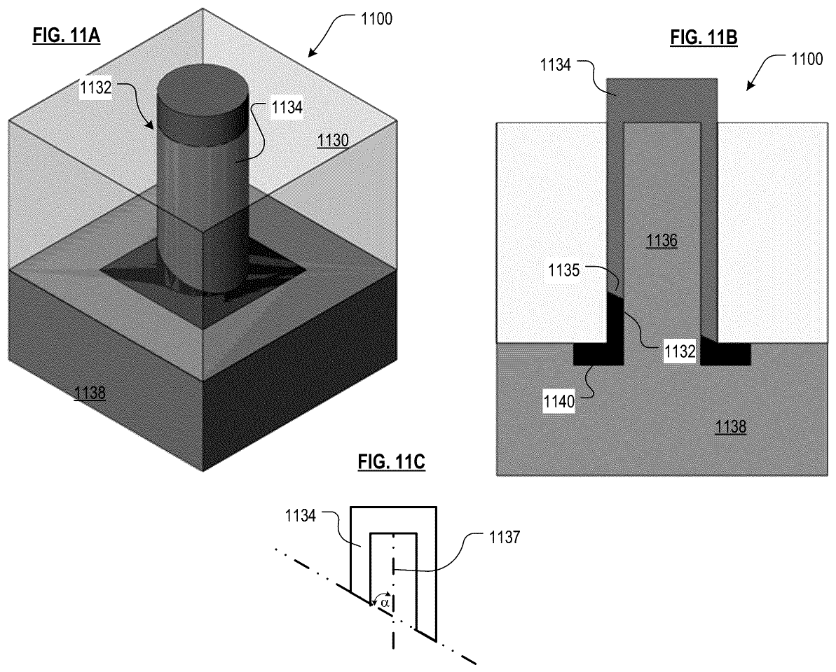

FIGS. 11A and 11B depict, via respective perspective and cross-sectional views, a fifth alternative embodiment of a sleeve-plunger in accordance with the present teachings. These figures depict compression-molding tool 1100 having male mold portion 1130 having plunger cavity 1132, and female mold portion 1138 including mold cavity 1140. Core pin 1136 extends from female mold portion 1138 into plunger cavity 1132.

Compression-molding tool 1100 additionally includes sleeve plunger 1134. In this embodiment, sleeve-plunger 1134 is intended to rotate. Bottom edge 1135 of sleeve-plunger 1134 is cut at an angle. As depicted in FIG. 11C, as a non-limiting example, bottom edge 1135 is inclined by angle, a, of about 60° with respect long axis 1137 of sleeve plunger 1134. Typically, angle α will be in the range of about 45° to about 80°. The height of bottom edge 1135 at its most advanced position in plunger cavity 1132 is slightly (e.g., a few millimeters) above the upper surface of the female mold portion 1138.

In operation, linear fiber-bundle-based preforms (not depicted) are placed in plunger cavity 1132 below sleeve plunger 1134. In accordance with compression molding protocols, the pressure and temperature are increased. The resin in the preforms is melted and sleeve plunger 1134 is fully advanced as depicted in FIG. 11B, which injects the preforms (now as “loose” fibers) into mold cavity 1140. Either before or after full consolidation of the fibers and resin, sleeve plunger 1134 is rotated within plunger cavity 1132. The rotation, such as two or three full rotations, causes fibers proximal to the surface of mold cavity 1140 to adopt a circular alignment around sleeve-plunger 1134. Thus, starting with linear preforms, compression-molding tool 1100 is capable of creating a circular fiber alignment similar to what is achieved using a ring-shape preform. Different fiber-alignment results can be achieved as a function of the rotation-speed profile, and the geometry of the bottom of sleeve-plunger 1134. For example, in some embodiments, the bottom surface of sleeve plunger includes teeth, has a “wave-like” pattern, etc.

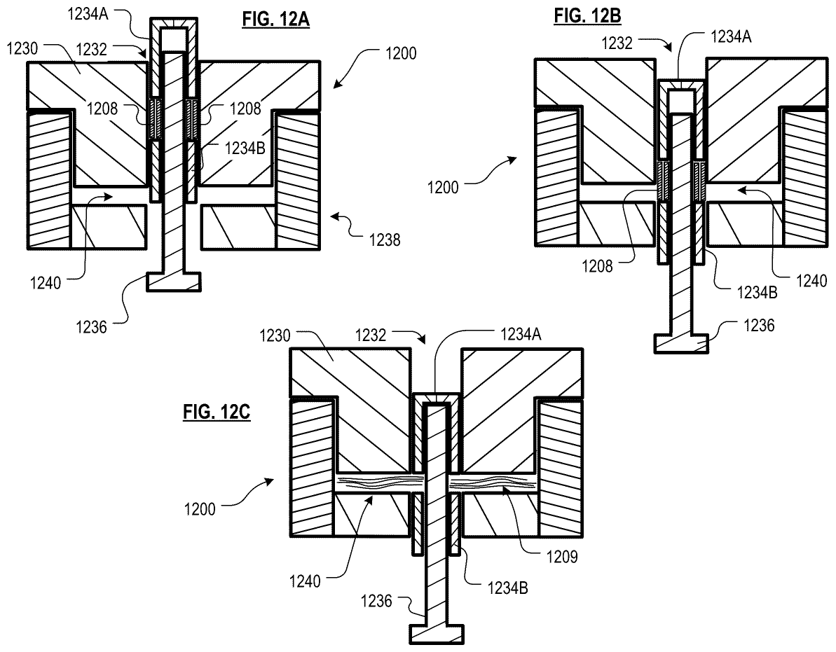

FIGS. 12A-12C depict, via cross-sectional views, a sixth alternative embodiment of a sleeve-plunger in accordance with the present teachings. These figures depict compression-molding tool 1200 having male mold portion 1230 having plunger cavity 1232, and female mold portion 1238 including mold cavity 1240. Core pin 1236 extends through female mold portion 1238 into plunger cavity 1232.

Compression molding tool 1200 also includes two (relatively shorter) sleeve-plungers 1234A and 12348. FIG. 12A depicts preforms 1208 situated between the two sleeve plungers, wherein the sleeve plungers are somewhat advanced through plunger cavity 1232. FIG. 12B depicts the sleeve plunger further advanced, wherein the upper surface of lower sleeve plunger 12348 is co-planar with the lower surface of mold cavity 1240, and a portion of the length of the fibers from preforms 1208 extend into the mold cavity.

It is notable that in this embodiment, lower sleeve plunger 12348 is fixed to core pin 1236, whereas upper sleeve plunger can move independently of the core pin. Furthermore, unlike the previous embodiments, in this embodiment, core pin 1236 is movable in the Z direction (vertically in the figure). In the state of the processing depicted in FIG. 12B, upper sleeve plunger 1234A has not moved (in the Z direction) relative to core pin 1236; that is, it has moved in concert with the core pin.

With lower sleeve plunger 12348 positioned as depicted in FIG. 12B, upper sleeve plunger 1234A is actuated to advance downwardly while core pin 1236 and lower sleeve plunger 1234 do not move. The continued advance of upper sleeve plunger 1234A forces fibers 1209 from preforms 1208 throughout mold cavity 1240.

In the state of the process depicted in FIG. 12C, the lower surface of upper sleeve plunger 1234A is co-planar with the lower surface of male mold portion 1230 and all fibers 1209 sourced from preforms 1208 have been injected into mold cavity 1240.

In this embodiment, core pin 1236 is movable, lower sleeve plunger 12348 is fixed to core pin 1236, and upper sleeve plunger 1234A is capable of moving independently of core pin 1236 via an appropriate actuator (not depicted). In some other embodiments, core pin 1236 is stationary and both of the sleeve-plungers movable with respect thereto. In still further embodiments, both sleeve plungers are fixed to core pin 1236 such that the gap between them is constant.

The embodiment depicted in FIGS. 12A through 12C can be used, for example, to control fiber alignment during the insertion of the preforms without affecting the preforms; that is, it eliminates collapsing the fibers during the transfer sequence.

The sequences (speed/position) can be varied to produce different results as to how the cavity fills. In some alternative embodiments, one or more of the sleeve-plungers can include the features discussed for earlier embodiments (e.g., multiple sections, etc.).

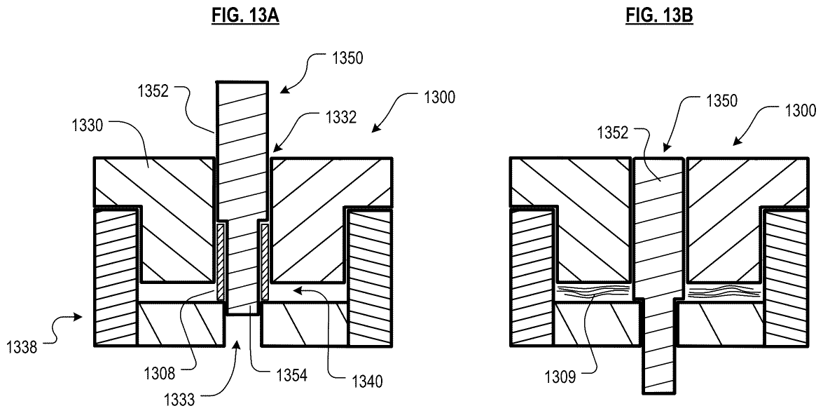

FIGS. 13A and 13B depict compression-molding tool 1300 having male mold portion 1330 having plunger cavity 1332, and female mold portion 1338 including mold cavity 1340.

Compression molding tool 1300 further includes plunger 1350, having upper portion 1352 and lower portion 1354. Upper portion 1352 of plunger 1350 has a diameter that is substantially the same as (just slightly smaller than) the diameter of plunger cavity 1332. Lower portion 1354 of plunger 1350 has a smaller diameter than plunger cavity 1332, and the resulting gap between the outer surface of lower portion of the plunger and the wall of plunger cavity 1332 provides a region for loading preforms, such as preforms 1308, in plunger cavity 1332. Furthermore, lower portion 1354 of plunger 1350 can receive a ring-shape preform, as in the previous embodiments. A core pin is not used for this embodiment of compression molding tool 1300. Female mold portion 1338 includes plunger cavity 1333, which is sized to receive lower portion 1354 of the plunger.

As depicted in FIG. 13B, as plunger 1350 is advanced through plunger cavities 1332 and 1333, fibers 1309 from preforms 1308 are injected throughout mold cavity 1340. In this fashion, plunger 1350 provides an equivalent functionality to the embodiments of the sleeve-plunger/core pin depicted in the previous figures. That is, and among other functionality, it can ensure a circular fiber alignment around a hole in a fiber composite part.

It is to be understood that the disclosure describes a few embodiments and that many variations of the invention can easily be devised by those skilled in the art after reading this disclosure and that the scope of the present invention is to be determined by the following claims.

What is claimed:

1. A compression-molding tool comprising:
a male portion having a plunger cavity extending therethrough;
a sleeve plunger movable within the plunger cavity, the sleeve plunger having a bore therein aligned with a longitudinal axis of the sleeve plunger;
a female portion having a mold cavity; and
a core pin extending from the female portion, through the mold cavity, and into the plunger cavity, wherein the core pin receives the bore of the sleeve plunger, the sleeve plunger movable along the core pin within the plunger cavity.

2. The compression-molding tool of claim 1 wherein the sleeve plunger comprises plural, longitudinally oriented sleeve sections.

3. The compression-molding tool of claim 2 wherein the sleeve sections are independently actuatable.

4. The compression-molding tool of claim 2 wherein a length of each of the plural sleeve sections is the same.

5. The compression-molding tool of claim 2 wherein at least one of the plural sleeve sections has a length that is different than a length of at least one other of the plural sleeve sections.

6. The compression-molding tool of claim 2 wherein at least some of the sleeve sections are concentrically arranged with respect to other of the plural sleeve sections.

7. The compression-molding tool of claim 1 wherein a first portion of the sleeve plunger is longer than a second portion of the sleeve plunger.

8. The compression-molding tool of claim 1 wherein a lower surface of the sleeve plunger is oriented at an acute angle with respect to the longitudinal axis of the sleeve plunger.

9. The compression-molding tool of claim 1 wherein the acute angle is between about 45 degrees to 80 degrees.

10. A compression-molding tool comprising:
a sleeve plunger movable within a plunger cavity, the sleeve plunger having a bore therein aligned with a longitudinal axis of the sleeve plunger, the sleeve plunger including plural, independently movable, longitudinally oriented sleeve sections;
a mold cavity; and
a core pin extending through the mold cavity and into the plunger cavity, wherein the core pin receives the bore of the sleeve plunger, the sleeve plunger movable along the core pin within the plunger cavity.

11. The compression-molding tool of claim 10 wherein a length of each of the plural sleeve sections is the same.

12. The compression-molding tool of claim 10 wherein at least one of the plural sleeve sections has a length that is different than a length of at least one other of the plural sleeve sections.

13. The compression-molding tool of claim 10 wherein at least some of the sleeve sections are concentrically arranged with respect to other of the plural sleeve sections.

14. The compression-molding tool of claim 1 wherein a first portion of the sleeve plunger is longer than a second portion of the sleeve plunger.

15. The compression-molding tool of claim 1 wherein a lower surface of the sleeve plunger is oriented at an acute angle with respect to the longitudinal axis of the sleeve plunger.

16. A method for forming, by compression molding, a fiber-composite part having a hole therein formed by a core pin that extends from a mold cavity, the method comprising:
positioning a ring-shape fiber-bundle-preform on the core pin of a compression-molding-tool;
pressurizing the mold cavity and melting a resin in the ring-shape fiber-bundle-preform;
advancing a sleeve plunger along the core pin, wherein the advancing of the sleeve plunger injects the melted resin and fibers sourced from the ring-shape fiber-bundle preform into the mold cavity, and positions the fibers proximal to and concentrically surrounding a site at which the core pin forms the hole, the core pin facilitating an alignment of the fibers corresponding to a circumference of the hole;
consolidating the resin and fibers by maintaining pressurization and temperature for a period of time; and
cooling and depressurizing the consolidated resin and fibers to form the fiber-composite part.

17. The method of claim 16 wherein advancing the sleeve plunger comprising advancing the sleeve plunger through a plunger cavity.

18. The method of claim 17 wherein the sleeve plunger includes at least first and second independently actuatable sleeve sections, and wherein positioning a ring-shape fiber-bundle-based preform on the core pin further comprises:
positioning, beneath the ring-shaped fiber-bundle preform:
(a) a first, relatively shorter, linear fiber-bundle-based preform in the plunger cavity below the first sleeve section of the sleeve plunger;
(b) a second, relatively longer, linear fiber-bundle-based preform in the plunger cavity below the second sleeve section of the sleeve plunger;
advancing the first sleeve section a first distance into the plunger cavity; and
advancing the second sleeve section a second distance into the plunger cavity, wherein the first distance is greater than the second distance.
